(19) United States
(12) Patent Application Publication
(10) Pub. No.: US 2022/0039035 A1
(43) Pub. Date: Feb. 3, 2022

(54) Enhancements For Sidelink Synchronization

(71) Applicant: MediaTek Singapore Pte. Ltd., Singapore (SG)

(72) Inventors: Tao Chen, Beijing (CN); Zhixun Tang, Beijing (CN); Min Lei, Beijing (CN)

(21) Appl. No.: 17/390,840

(22) Filed: Jul. 30, 2021

(30) Foreign Application Priority Data
Aug. 3, 2020 (CN) PCT/CN2020/106619
Jul. 5, 2021 (CN) 202110755790.4

(51) Int. Cl. H04W 56/00; H04L 5/00; H04W 4/40; H04W 76/28

(52) U.S. Cl. CPC H04W 56/001; H04L 5/0048; H04W 56/0055; H04W 76/28; H04W 4/40

(57) ABSTRACT

Various examples and schemes pertaining to enhancements for sidelink (SL) synchronization in New Radio (NR) vehicle-to-everything (V2X) communications are described. A user equipment (UE) establishes synchronization with one other UE in a vehicle-to-everything (V2X) network based on a partial search or signaling. The UE performs a sidelink (SL) communication with the other UE upon the synchronization being established. The UE also maintains the SL communication during a SL synchronization reference change by either of the UEs.

### CROSS REFERENCE TO RELATED PATENT APPLICATION(S)

The present claims the priority benefit of China Patent Application No. CN 202110755790.4, filed 5 Jul. 2021, which is part of a Chinese national stage application of PCT Application No. PCT/CN2020/106619, filed 3 Aug. 2020. Contents of aforementioned applications are herein incorporate by reference in their entirety.

### TECHNICAL FIELD

The present disclosure is generally related to wireless communications and, more particularly, to enhancements for sidelink (SL) synchronization such as SL synchronization in New Radio (NR) vehicle-to-everything (V2X) communications.

### BACKGROUND

Unless otherwise indicated herein, approaches described in this section are not prior art to the claims listed below and are not admitted as prior art by inclusion in this section.

Under the 3^{rd} Generation Partnership Project (3GPP) specifications for 5th Generation (5G) NR, V2X SL communication can be supported by unicast, groupcast and broadcast communications. However, there remain certain issues that need to be addressed with respect to SL synchronization. For instance, the issue of how a user equipment (UE) can reduce power consumption during SL discontinuous reception (DRX) while maintaining synchronization to achieve performance in data transmission and/or reception needs to be addressed. Therefore, there is a need for a solution of enhancements for SL synchronization.

### SUMMARY

The following summary is illustrative only and is not intended to be limiting in any way. That is, the following summary is provided to introduce concepts, highlights, benefits and advantages of the novel and non-obvious techniques described herein. Selected implementations are further described below in the detailed description. Thus, the following summary is not intended to identify essential features of the claimed subject matter, nor is it intended for use in determining the scope of the claimed subject matter.

One objective of the present disclosure is to propose various schemes, concepts, designs, methods, systems and apparatuses pertaining to enhancements for SL synchronization. It is believed that various schemes proposed herein may provide enhancements for SL synchronization as a way to address certain issues in V2X communications.

In one aspect, a method may involve establishing synchronization in a V2X network based on a partial search or signaling. The method may also involve performing a SL communication upon the synchronization being established.

In another aspect, a method may involve establishing synchronization in a V2X network. The method may also involve maintaining a SL communication during a SL synchronization reference change by using signaling via one or more of a wakeup channel, a first sidelink control information (SCI) of a two-stage SCI transmission, a second SCI of the two-stage SCI transmission, and a data channel.

It is noteworthy that, although description provided herein may be in the context of certain radio access technologies, networks and network topologies such as 5G/NR V2X, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Wireless Fidelity (Wi-Fi) and any future-developed networks and technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with the present disclosure.

FIG. 2 is a diagram of an example scenario in accordance with the present disclosure.

FIG. 3 is a diagram of an example scenario in accordance with the present disclosure.

FIG. 4 is a block diagram of an example communication environment in which various proposed schemes in accordance with the present disclosure may be implemented.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements for SL synchronization in NR V2X communications. According to the present disclosure, a number of possible solutions or schemes may be implemented separately or jointly. That is, although these possible solutions/schemes may be described below separately, two or more of these possible solutions/schemes may be implemented in one combination or another.

Under a proposed scheme in accordance with the present disclosure, for SL synchronization especially during a SL DRX operation, a UE may perform a partial search (e.g., based on some subframes/slots and/or detection of some SL synchronization signal (SLSS) identities (SSIDs)). Compared to a full search over all subframes/slots for all SSIDs, the partial search may save UE power significantly. However, it is possible that a given synchronization reference (SyncRef) may be lost (e.g., due to the UE being out of an effective communication range with the SyncRef or due to obstruction of the SyncRef by an object or structure) in the partial search such that synchronization performance may be negatively impacted. To avoid such a problem, the UE may perform a full search within a given duration (e.g., 160 ms SLSS transmission periodicity) with a configured or preconfigured (herein denoted as “(pre-)configured”) periodicity. In such cases, the UE may perform the full search for all SSIDs over some periodic time durations. For example, with an SSID transmitted with a 160 ms periodicity, the UE may perform a full search over a 160 ms searching window with a (pre-)configured periodicity (e.g., every 1 s). Thus, the UE may perform the full search for all SSIDs over a 160 ms duration with the time interval or periodicity of 1 s. In such cases, the full search may be applied for all SSIDs but not on all time subframes/slots. Accordingly, such a full search may be considered as a kind of partial search with full SSID detection during the searching window.

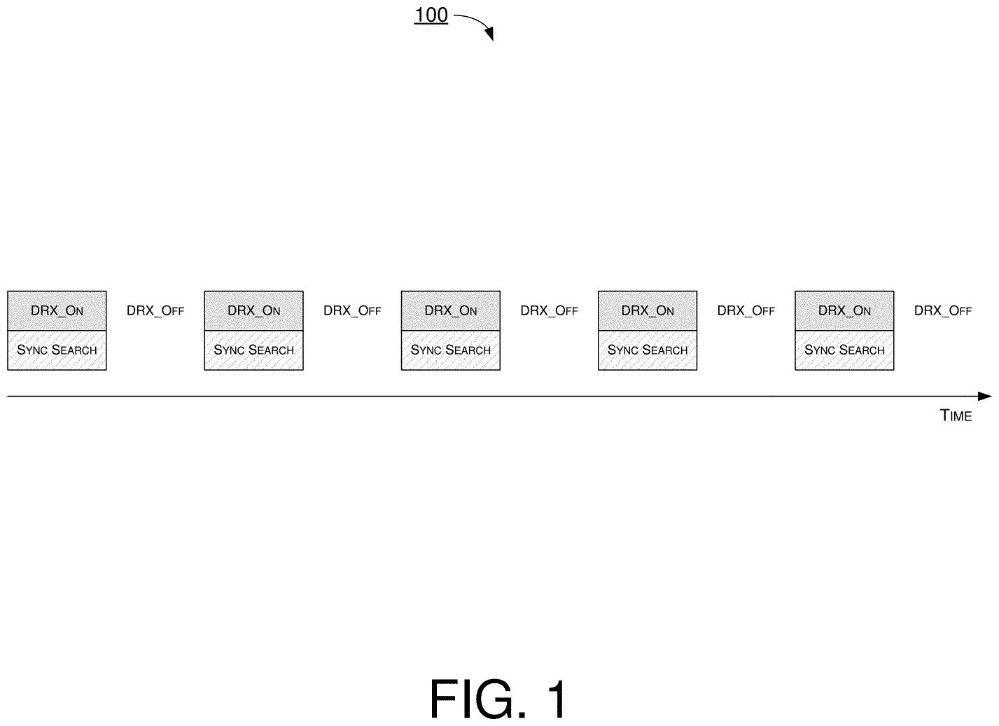

Under a proposed scheme in accordance with the present disclosure, the UE may perform both partial search and full search (or two types of partial searches) periodically with (pre-)configured search patterns defined based on a periodicity, a duration and/or a starting timing offset. Such patterns may be (pre-)configured independently or jointly. The duration of the search patterns may fall within a SL DRX_On duration (e.g., a period of time during which a UE in a DRX mode or operation wakes up to perform monitoring, transmission and/or reception) to save UE power in case SL DRX is enabled. FIG. 1 illustrates an example scenario 100 of a SL synchronization search with a DRX operation for power saving in accordance with the present disclosure. In scenario 100, a UE may be (pre-)configured with a search pattern that coincides or otherwise is aligned with a pattern of the DRX operation so that the UE may perform the search during or within each DRX_On duration and not during any other time (e.g., with no search performed during each DRX_Off duration which is a period of time during which the UE in the DRX operation enters a low-power or sleep mode to minimize power consumption).

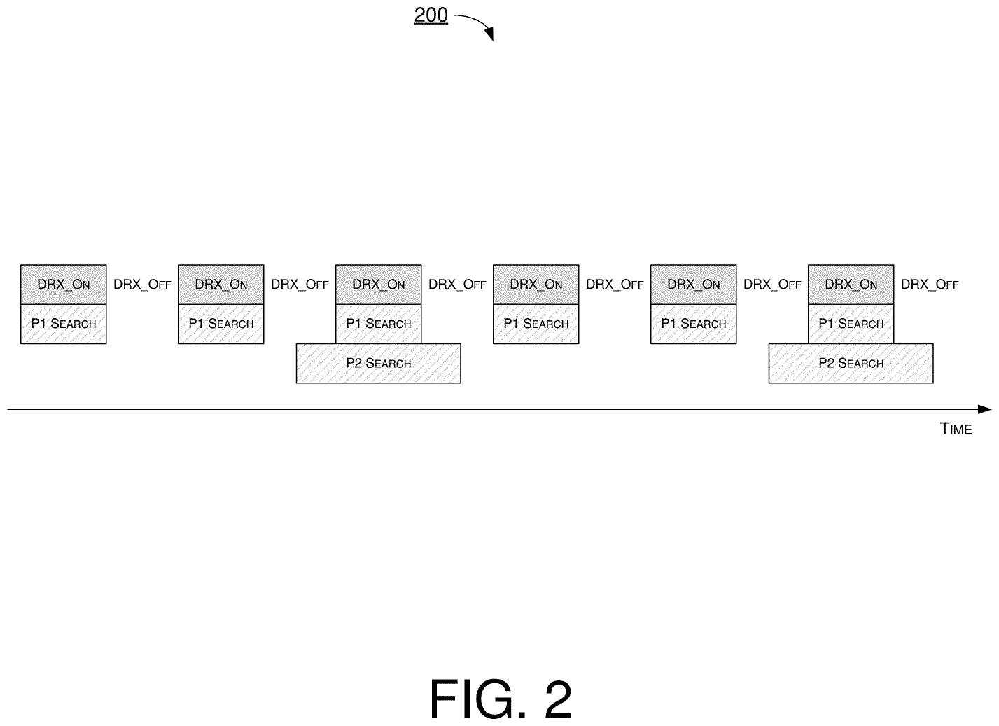

FIG. 2 illustrates an example scenario 200 of a dual-period SL synchronization search with a DRX operation in accordance with the present disclosure. In scenario 200, the dual-period SL synchronization search may involve a first synchronization search pattern (denoted as “P1 search” in FIG. 2) and a second synchronization search pattern (denoted as “P2 search” in FIG. 2). Each P1 synchronization search may coincide with a corresponding DRX_On duration, and each P2 synchronization search may overlap with a respective P1 synchronization search but with a longer search duration (by extending into DRX_Off duration(s) of either or both DRX_Off durations adjacent a DRX_On duration corresponding to the respective P1 synchronization search). Compared to scenario 100, in scenario 200, in addition to a P1 synchronization search pattern configuration the UE may also be (pre-)configured with another search pattern (namely, a P2 synchronization search pattern) for full search of all SSIDs within a duration (e.g., over a 160 ms duration which may be an SSID transmission interval) with a (pre-)configured periodicity (e.g., every 1 s). In such cases, the UE may perform a dual-period SL synchronization search for detection of a candidate SSID and to find a suitable SyncRef. When the two patterns of the dual-period SL synchronization search overlap each other, a superposition of the two patterns may be applied for SL SyncRef search. It is noteworthy that the SL synchronization search in scenario 200 may be limited and performed during and around (e.g., before and/or after) DRX_On durations.

Under a proposed scheme in accordance with the present disclosure, in case the UE has synchronized to a Global Navigation Satellite System (GNSS) and/or a BS directly as a SyncRef of the highest priority, any (pre-)configured search pattern(s) may be ignored or disabled automatically. Otherwise, the UE may apply the (pre-)configured search pattern(s) for search. Such search pattern(s) may be applied independently with SL DRX operations.

Under a proposed scheme in accordance with the present disclosure, a Rx UE may receive reference signals and/or data from a Tx UE to perform synchronization. Under the proposed scheme, the Rx UE may skip or reduce some or all occasions of SLSS search and detection. Additionally, the Tx UE may transmit wakeup signals/channels to cause the Rx UE to sleep or wake up during a DRX_On duration. Moreover, the Rx UE may use at least a demodulation reference signal (DMRS) of the wakeup signals/channels for synchronization during the DRX operation, especially for unicast communications. Such wakeup signals/channels may be transmitted periodically associated with each DRX_On duration. Furthermore, such wakeup signals/channels transmission may be based on a configured grant from the Tx UE or a BS for resource selection and/or resource reservation.

Under the proposed scheme, the wakeup signals/channels may be based on a standalone two-stage SCI transmission of a first SCI and a second SCI, with the second SCI carrying information about which one or multiple UE(s) is/are to wake up in an upcoming DRX_On duration. In such cases, there may be no need of an associated data channel, which may be indicated by one bit as an indication of the presence (or absence) of the data channel or as an indication of a new second SCI format for wakeup message(s) without the associated data channel. For example, a bitmap of multiple bits with each bit representing a respective UE or a respective UE identifier (ID) may be carried in the second SCI to indicate which UE(s) is/are to wake up. Alternatively, such wakeup information may be carried in an associated data channel. Moreover, a DMRS in the first SCI and/or the second SCI and/or data may be used for SL synchronization at the Rx UE.

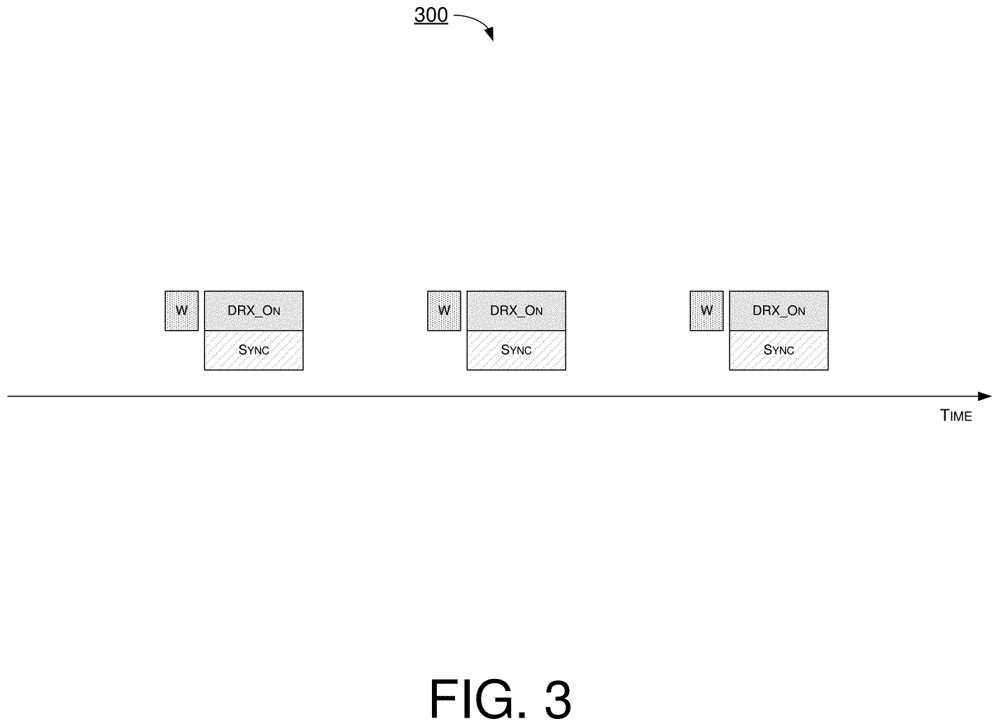

FIG. 3 illustrates an example scenario 300 of a synchronization search based on wakeup signals/channels with a DRX operation under a proposed scheme in accordance with the present disclosure. In scenario 300, SL synchronization searches may be based on wakeup signal(s). That is, a synchronization search during the DRX_On duration may not be necessary in scenario 300. Instead, in scenario 300, a UE may use wakeup signals/channels (denoted as “W” in FIG. 3) to perform synchronization with another UE (e.g., Tx UE) especially in case of unicast communications. Under the proposed scheme, wakeup signals/channels may be the only signals/channels to be detected by a UE (e.g., Rx UE) for both wakeup and synchronization purposes (e.g., when there is no traffic during DRX operation). Advantageously, the UE may reduce power consumption significantly.

Under a proposed scheme in accordance with the present disclosure, in case a Tx UE changes SyncRef, the Tx UE may inform the Rx UE about the SyncRef change by signaling via wakeup channel(s), first and/or second SCI and/or data channel. The Rx UE may receive from the Tx UE new timing information for subsequence communications with the Tx UE. The signaling of the new timing information from the Tx UE may indicate a timing offset as a difference between a new synchronization timing and a current synchronization timing in use for communications between the Tx UE and the Rx UE. The timing offset may be indicated in terms of a frame offset (e.g., by a number of frames), a slot offset (e.g., by a number of slots) and/or a symbol offset (e.g., by a number of symbols). Additionally, the signaling of new timing information may indicate a point in time, or a time instant, at which the new synchronization timing becomes effective (so that the Tx UE and Rx UE are to start using the new synchronization timing). Alternatively, the Rx UE may assume that the new synchronization timing would be applied after a predefined period of time (e.g., X number of slots or Y number of milliseconds). Both the Tx UE and Rx UE may stay in communication during the SyncRef change.

Under a proposed scheme in accordance with the present disclosure, the Rx UE may determine an occurrence of SL radio link failure (RLF) based on a SL radio link monitoring (RLM) measurement performed by the Rx UE over the wakeup signals/channels. For example, the Rx UE may measure a DMRS of the wakeup signals/channels to report the measured channel quality, out-of-synchronization (OoS) and/or in-synchronization (IS) periodically for an higher layer to determine the occurrence of the RLF (e.g., after some layer 3 filtering on the measurement results or reported indications).

Under a proposed scheme in accordance with the present disclosure with respect to selection of sidelink synchronization signal block (S-SSB) or DMRS/wakeup signal (WUS) as SyncRef, a UE may be (pre-)configured by signaling as to whether to perform: (1) SSID detection-based synchronization search for synchronization and/or (2) a wakeup channel DMRS/sequence-based synchronization. In some implementations, the UE may be (pre-)configured to perform either or both methods of synchronization.

Under a proposed scheme in accordance with the present disclosure, in case of multiple unicast communications from multiple Tx UEs to one Rx UE, the Rx UE may select one of the multiple Tx UEs, which has a DMRS with the strongest reference signal received power (RSRP) among the DMRSs of the multiple Tx UEs, as the synchronization reference or SyncRef. Alternatively, the Rx UE may select one of the multiple Tx UEs, which has a DMRS associated with the highest priority level among the priorities associated with the DMRSs of the multiple Tx UEs, as the synchronization reference. The priority level may be (pre-)configured per unicast communication or indicated in physical control channels such as, for example and without limitation, the first SCI and/or the second SCI of a standalone two-stage SCI signaling. Alternatively, the Rx UE may use both RSRP and priority level jointly to determine which Tx UE's DMRS to be selected and used for synchronization reference. For example, the Rx UE may select the Tx UE's DMRS firstly according to its priority level. In case of multiple candidate Tx UEs with the same priority level, the Rx UE may select the one Tx UE having a DMRS with the best channel quality (e.g., strongest RSRP and/or best reference signal received quality (RSRQ)) as the synchronization reference. Additionally, depending on UE capability, the Rx UE may maintain multiple synchronization references based on multiple Tx UEs' DMRSs for multiple unicast communications.

Under a proposed scheme in accordance with the present disclosure, in case a UE is synchronized to a priority group with a priority level higher than a predefined priority (e.g., higher that the priority level of a certain priority group), the UE may perform a synchronization search within +/−x (e.g., x=1 or 2) symbols (or slots) of a current synchronization timing as a limited synchronization search. Otherwise, the UE may need to perform a full synchronization search over all subframes/slots for all SSIDs. The certain priority group may include one or more synchronization reference UEs promoting themselves as the synchronization references without any synchronization to other synchronization references. Alternatively, the certain priority group may include one or more synchronization reference UEs synchronized to the GNSS or a BS with more than Y (e.g., Y>=2) hops. In either case, such certain priority group may be considered as having a lower/lowest priority (relative to other synchronization reference(s)) for synchronization search and larger timing error due to multiple hops or loss of synchronization.

Under a proposed scheme in accordance with the present disclosure, considering an asynchronization cellular network, an indicator or signaling may be utilized to inform a UE whether it is possible to perform a limited synchronization search or a full synchronization search. Such indicator may be set per band/frequency to indicate whether all BSs are synchronized in a given band or a given frequency layer. Alternatively, such indicator may be set for multiple bands/frequencies to indicate whether all BSs are synchronized across multiple bands/frequency layers. Under the proposed scheme, the indicator in the uu interface may be reused for synchronization indication or transmitted in a system information block (SIB), radio resource control (RRC), or SL RRC for SL operation. In case the indicator is set as “true” or “synced”, the UE may assume that the BSs and one or more synchronization reference UEs synchronized to different BSs are still in synchronization (e.g., with a limited timing offset), and the UE may perform a limited synchronization search. Otherwise, the UE may need to perform a full sync search.

### Illustrative Implementations

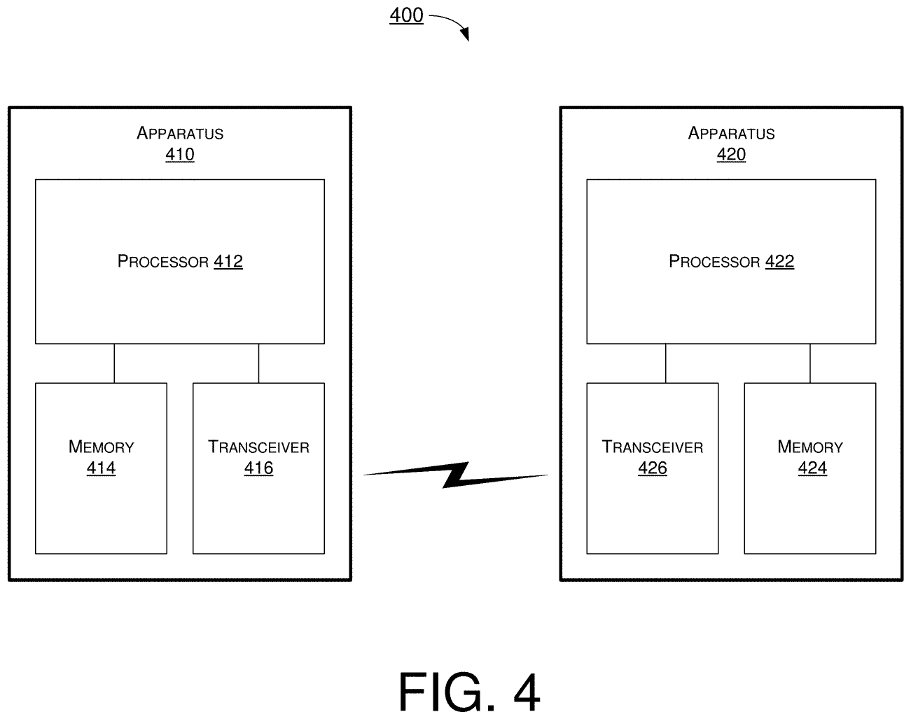

FIG. 4 illustrates an example communication environment 400 having an example apparatus 410 and an example apparatus 420 in accordance with an implementation of the present disclosure. Each of apparatus 410 and apparatus 420 may perform various functions to implement schemes, techniques, processes and methods described herein pertaining to enhancements for SL synchronization in NR V2X communications, including various schemes described herein.

Each of apparatus 410 and apparatus 420 may be a part of an electronic apparatus, which may be a UE such as a vehicle, a portable or mobile apparatus, a wearable apparatus, a wireless communication apparatus or a computing apparatus. For instance, each of apparatus 410 and apparatus 420 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 410 and apparatus 420 may also be a part of a machine type apparatus, which may be an IoT or NB-IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker or a home control center. Alternatively, each of apparatus 410 and apparatus 420 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Each of apparatus 410 and apparatus 420 may include at least some of those components shown in FIG. 4 such as a processor 412 and a processor 422, respectively. Each of apparatus 410 and apparatus 420 may further include one or more other components not pertinent to the proposed scheme of the present disclosure (e.g., internal power supply, display device and/or user interface device), and, thus, such component(s) of each of apparatus 410 and apparatus 420 are neither shown in FIG. 4 nor described below in the interest of simplicity and brevity.

In some implementations, at least one of apparatus 410 and apparatus 420 may be a part of an electronic apparatus, which may be a vehicle, a roadside unit (RSU), network node or base station (e.g., eNB, gNB or TRP), a small cell, a router or a gateway. For instance, at least one of apparatus 410 and apparatus 420 may be implemented in a vehicle in a V2V or V2X network, an eNodeB in an LTE, LTE-Advanced or LTE-Advanced Pro network or in a gNB in a 5G, NR, IoT or NB-IoT network. Alternatively, at least one of apparatus 410 and apparatus 420 may be implemented in the form of one or more IC chips such as, for example and without limitation, one or more single-core processors, one or more multi-core processors, one or more RISC processors, or one or more CISC processors.

In one aspect, each of processor 412 and processor 422 may be implemented in the form of one or more single-core processors, one or more multi-core processors, one or more RISC processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including enhancements for SL synchronization in NR V2X communications in accordance with various implementations of the present disclosure.

In some implementations, apparatus 410 may also include a transceiver 416, as a communication device, coupled to processor 412 and capable of wirelessly transmitting and receiving data. In some implementations, apparatus 410 may further include a memory 414 coupled to processor 412 and capable of being accessed by processor 412 and storing data therein. In some implementations, apparatus 420 may also include a transceiver 426, as a communication device, coupled to processor 422 and capable of wirelessly transmitting and receiving data. In some implementations, apparatus 420 may further include a memory 424 coupled to processor 422 and capable of being accessed by processor 422 and storing data therein. Accordingly, apparatus 410 and apparatus 420 may wirelessly communicate with each other via transceiver 416 and transceiver 426, respectively.

To aid better understanding, the following description of the operations, functionalities and capabilities of each of apparatus 410 and apparatus 420 is provided in the context of a NR V2X communication environment in which apparatus 410 is implemented in or as a wireless communication device, a communication apparatus or a first UE and apparatus 420 is implemented in or as wireless communication device, a communication apparatus or a second UE.

Under various proposed schemes pertaining to enhancements for SL synchronization in NR V2X communications in accordance with the present disclosure, processor 422 of apparatus 420, as a second UE, may establish, via transceiver 426, synchronization with apparatus 410, as a first UE, in a V2X network based on a partial search or signaling. Moreover, processor 422 may perform, via transceiver 426, a SL communication with apparatus 410 upon the synchronization being established. Similarly, processor 412 of apparatus 410, as a first UE, may perform the same operations described above with respect to processor 422.

In some implementations, in establishing the synchronization, processor 422 may perform certain operations. For instance, processor 422 may perform a limited synchronization search within one or few slots or symbols of a current synchronization timing responsive to being synchronized to a priority group with a priority level higher than a predefined priority. Alternatively, processor 422 may perform a full synchronization search when otherwise (e.g., in case apparatus 420 is not synchronized to any priority group with a priority level higher than the predefined priority).

In some implementations, in establishing the synchronization, processor 422 may select a first DMRS from apparatus 410 as a first UE among a plurality of DMRSs from a plurality of UEs as a synchronization reference when apparatus 420 is in unicast communications with the plurality of UEs. In some implementations, in selecting the first DMRS from the first UE as the synchronization reference, processor 422 may select the first DMRS in response to either or both of: (a) a RSRP of the first DMRS being higher than RSRPs of other DMRSs of the plurality of DMRSs; and (b) a priority level associated with the first DMRS being higher than priority levels of the other DMRSs of the plurality of DMRSs.

In some implementations, in establishing the synchronization, processor 422 may maintain a plurality of synchronization references based on a plurality of DMRSs from a plurality of UEs in a plurality of unicast communications with the plurality of UEs.

In some implementations, in establishing the synchronization, processor 422 may perform certain operations. For instance, processor 422 may select either or both of a S-SSB and a DMRS as a synchronization reference. Additionally, processor 422 may perform synchronization based on either or both of: (a) a SSID detection-based synchronization search, and (b) a wakeup channel DMRS or sequence-based synchronization. In some implementations, in selecting, processor 422 may select based on pre-configured information or selecting based on a configuration received in a signal.

In some implementations, in establishing the synchronization, processor 422 may perform SL synchronization based on a DMRS in one or more of a first SCI of a two-stage SCI transmission, a second SCI of the two-stage SCI transmission, and a data channel. In some implementations, in performing the SL communication, processor 422 may receive (e.g., from apparatus 410) a bitmap or an ID (e.g., UE ID) carried in the second SCI indicating which one or more UE(s) is/are to wake up in a DRX operation during a DRX_On duration.

In some implementations, in performing the SL communication, processor 422 (and processor 412) may maintain the SL communication between apparatus 410 as a first UE and apparatus 420 as a second UE. For instance, processor 412 may transmit, via transceiver 416, a signal to inform apparatus 420 of a SL synchronization reference change by apparatus 410. Moreover, processor 422 may receive the signal and determine a new synchronization timing, which is used by apparatus 410 and apparatus 420 in maintaining the SL communication during the SL synchronization reference change by apparatus 410. In some implementations, the signal may indicate information related to the new synchronization timing by indicating either: (a) a timing offset as a difference between the new synchronization timing and a current synchronization timing, or (b) a point in time at which the new synchronization timing becomes effective. In some implementations, in determining the new synchronization timing, processor 422 may determine to apply the new synchronization timing after a predefined period of time. In some implementations, in transmitting the signal, processor 412 may signal to apparatus 420 via one or more of a wakeup channel, a first SCI of a two-stage SCI transmission, a second SCI of the two-stage SCI transmission, and a data channel.

In some implementations, in establishing the synchronization, processor 422 may perform a SL synchronization search according to a search pattern which is aligned with a pattern of a DRX operation by performing a search during each of a plurality of DRX_On durations of the DRX operation. Alternatively, in establishing the synchronization, processor 422 may perform a dual-period SL synchronization search according to a first search pattern and a second search pattern each of which being aligned with a pattern of the DRX operation by: (a) performing a first search during each of a plurality of DRX_On durations of the DRX operation; and (b) performing a second search longer than the first search during and around each of some but not all of the plurality of DRX_On durations. Still alternatively, in establishing the synchronization, processor 422 may synchronize with apparatus 410 based on a WUS transmitted by apparatus 410 to apparatus 420.

Under various proposed schemes pertaining to enhancements for SL synchronization in NR V2X communications in accordance with the present disclosure, processor 422 of apparatus 420, as a second UE, may establish, via transceiver 426, synchronization with apparatus 410, as a first UE, in a V2X network (e.g., based on a partial search or signaling). Moreover, processor 422 may maintain, via transceiver 426, a SL communication with apparatus 410 during a SL synchronization reference change by using signaling via one or more of a wakeup channel, a first SCI of a two-stage SCI transmission, a second SCI of the two-stage SCI transmission, and a data channel. Similarly, processor 412 of apparatus 410, as a first UE, may perform the same operations described above with respect to processor 422.

In some implementations, in maintaining of the SL communication between apparatus 410 and apparatus 420, each of processor 412 and processor 422 may perform certain operations. For instance, processor 412 may transmit, via transceiver 416, a signal to inform apparatus 420 of a SL synchronization reference change by apparatus 410. Moreover, processor 422 may receive the signal and determine a new synchronization timing which is used by apparatus 410 and apparatus 420 in maintaining the SL communication during the SL synchronization reference change by apparatus 410.

In some implementations, the signal may indicate information related to the new synchronization timing by indicating either: (a) a timing offset as a difference between the new synchronization timing and a current synchronization timing, or (b) a point in time at which the new synchronization timing becomes effective.

In some implementations, in determining the new synchronization timing, processor 422 may determine to apply the new synchronization timing after a predefined period of time.

### Illustrative Processes

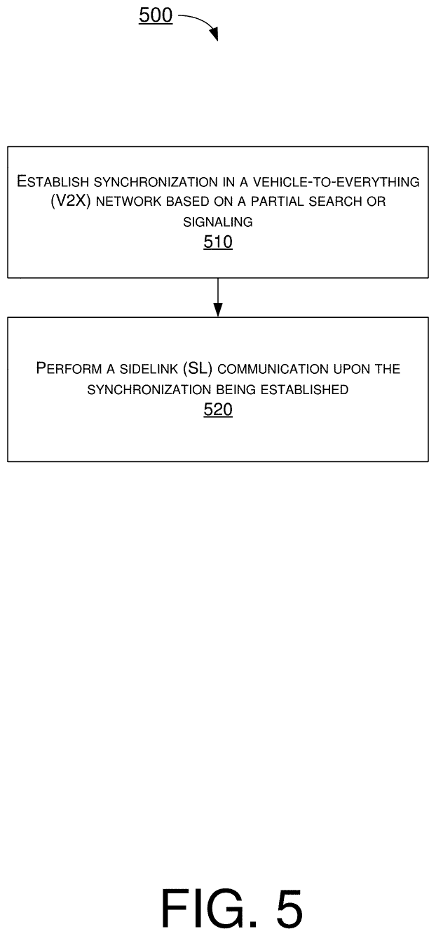

FIG. 5 illustrates an example process 500 in accordance with an implementation of the present disclosure. Process 500 may be an example implementation of the proposed schemes described above with respect to enhancements for SL synchronization in NR V2X communications in accordance with the present disclosure. Process 500 may represent an aspect of implementation of features of apparatus 410 and apparatus 420. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may also be repeated partially or entirely. Process 500 may be implemented by apparatus 410, apparatus 420 and/or any suitable wireless communication device, UE, roadside unit (RUS), base station or machine type devices. Solely for illustrative purposes and without limitation, process 500 is described below in the context of apparatus 410 as a first UE (such as a Tx UE or a Rx UE in a V2X network) and apparatus 420 as a second UE (such as a Rx UE or a Tx UE in the V2X network). Process 500 may begin at block 510.

At 510, process 500 may involve processor 422 of apparatus 420, as a second UE, establishing, via transceiver 426, synchronization with apparatus 410, as a first UE, in a V2X network based on a partial search or signaling. Process 500 may proceed from 510 to 520.

At 520, process 500 may involve processor 422 performing, via transceiver 426, a SL communication with apparatus 410 upon the synchronization being established.

In some implementations, in establishing the synchronization, process 500 may involve processor 422 performing certain operations. For instance, process 500 may involve processor 422 performing a limited synchronization search within one or few slots or symbols of a current synchronization timing responsive to being synchronized to a priority group with a priority level higher than a predefined priority. Alternatively, process 500 may involve processor 422 performing a full synchronization search when otherwise (e.g., in case apparatus 420 is not synchronized to any priority group with a priority level higher than the predefined priority).

In some implementations, in establishing the synchronization, process 500 may involve processor 422 selecting a first DMRS from apparatus 410 as a first UE among a plurality of DMRSs from a plurality of UEs as a synchronization reference when apparatus 420 is in unicast communications with the plurality of UEs. In some implementations, in selecting the first DMRS from the first UE as the synchronization reference, process 500 may involve processor 422 selecting the first DMRS in response to either or both of: (a) a RSRP of the first DMRS being higher than RSRPs of other DMRSs of the plurality of DMRSs; and (b) a priority level associated with the first DMRS being higher than priority levels of the other DMRSs of the plurality of DMRSs.

In some implementations, in establishing the synchronization, process 500 may involve processor 422 maintaining a plurality of synchronization references based on a plurality of DMRSs from a plurality of UEs in a plurality of unicast communications with the plurality of UEs.

In some implementations, in establishing the synchronization, process 500 may involve processor 422 performing certain operations. For instance, process 500 may involve processor 422 selecting either or both of a S-SSB and a DMRS as a synchronization reference. Additionally, process 500 may involve processor 422 performing synchronization based on either or both of: (a) a SSID detection-based synchronization search, and (b) a wakeup channel DMRS or sequence-based synchronization. In some implementations, in selecting, process 500 may involve processor 422 selecting based on pre-configured information or selecting based on a configuration received in a signal.

In some implementations, in establishing the synchronization, process 500 may involve processor 422 performing SL synchronization based on a DMRS in one or more of a first SCI of a two-stage SCI transmission, a second SCI of the two-stage SCI transmission, and a data channel. In some implementations, in performing the SL communication, process 500 may involve processor 422 receiving a bitmap or an ID (e.g., UE ID) carried in the second SCI indicating which one or more UE(s) is/are to wake up in a DRX operation during a DRX_On duration.

In some implementations, in performing the SL communication, process 500 may involve processor 422 (and processor 412) maintaining the SL communication between apparatus 410 a first UE and apparatus 420 as a second UE. For instance, process 500 may involve processor 412 transmitting, via transceiver 416, a signal to inform apparatus 420 of a SL synchronization reference change by apparatus 410. Moreover, process 500 may involve processor 422 receiving the signal and determining a new synchronization timing, which is used by apparatus 410 and apparatus 420 in maintaining the SL communication during the SL synchronization reference change by apparatus 410. In some implementations, the signal may indicate information related to the new synchronization timing by indicating either: (a) a timing offset as a difference between the new synchronization timing and a current synchronization timing, or (b) a point in time at which the new synchronization timing becomes effective. In some implementations, in determining the new synchronization timing, process 500 may involve processor 422 determining to apply the new synchronization timing after a predefined period of time. In some implementations, in transmitting the signal, process 500 may involve processor 412 signaling to apparatus 420 via one or more of a wakeup channel, a first SCI of a two-stage SCI transmission, a second SCI of the two-stage SCI transmission, and a data channel.

In some implementations, in establishing the synchronization, process 500 may involve processor 422 performing a SL synchronization search according to a search pattern which is aligned with a pattern of a DRX operation by performing a search during each of a plurality of DRX_On durations of the DRX operation. Alternatively, in establishing the synchronization, process 500 may involve processor 422 performing a dual-period SL synchronization search according to a first search pattern and a second search pattern each of which being aligned with a pattern of the DRX operation by: (a) performing a first search during each of a plurality of DRX_On durations of the DRX operation; and (b) performing a second search longer than the first search during and around each of some but not all of the plurality of DRX_On durations. Still alternatively, in establishing the synchronization, process 500 may involve processor 422 synchronizing with apparatus 410 based on a WUS transmitted by apparatus 410 to apparatus 420.

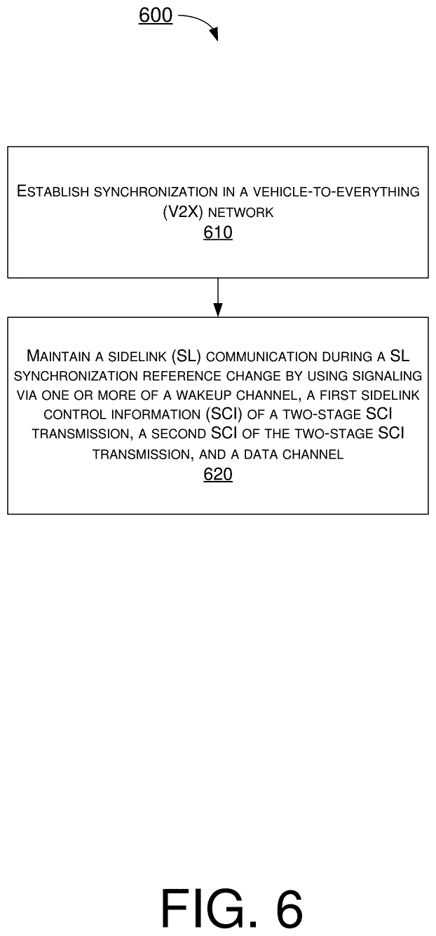

FIG. 6 illustrates an example process 600 in accordance with an implementation of the present disclosure. Process 600 may be an example implementation of the proposed schemes described above with respect to enhancements for SL synchronization in NR V2X communications in accordance with the present disclosure. Process 600 may represent an aspect of implementation of features of apparatus 410 and apparatus 420. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 410, apparatus 420 and/or any suitable wireless communication device, UE, roadside unit (RUS), base station or machine type devices. Solely for illustrative purposes and without limitation, process 600 is described below in the context of apparatus 410 as a first UE (such as a Tx UE or a Rx UE in the V2X network) and apparatus 420 as a second UE (such as a Rx UE or a Tx UE in a V2X network). Process 600 may begin at block 610.

At 610, process 600 may involve processor 422 of apparatus 420, as a second UE, establishing, via transceiver 426, synchronization with apparatus 410, as a first UE, in a V2X network (e.g., based on a partial search or signaling). Process 600 may proceed from 610 to 620.

At 620, process 600 may involve processor 422 maintaining, via transceiver 426, a SL communication with apparatus 410 during a SL synchronization reference change by using signaling via one or more of a wakeup channel, a first SCI of a two-stage SCI transmission, a second SCI of the two-stage SCI transmission, and a data channel.

In some implementations, in maintaining of the SL communication between apparatus 410 and apparatus 420, process 600 may involve each of processor 412 and processor 422 performing certain operations. For instance, process 600 may involve processor 412 transmitting, via transceiver 416, a signal to inform apparatus 420 of a SL synchronization reference change by apparatus 410. Moreover, process 600 may involve processor 422 determining a new synchronization timing which is used by apparatus 410 and apparatus 420 in maintaining the SL communication during the SL synchronization reference change by apparatus 410.

In some implementations, the signal may indicate information related to the new synchronization timing by indicating either: (a) a timing offset as a difference between the new synchronization timing and a current synchronization timing, or (b) a point in time at which the new synchronization timing becomes effective.

In some implementations, in determining the new synchronization timing, process 600 may involve processor 422 determining to apply the new synchronization timing after a predefined period of time.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing synchronization in a vehicle-to-everything (V2X) network based on a partial search or signaling; and
performing a sidelink (SL) communication upon the synchronization being established.

2. The method of claim 1, wherein the establishing of the synchronization comprises:
performing a limited synchronization search within one or few slots or symbols of a current synchronization timing responsive to being synchronized to a priority group with a priority level higher than a predefined priority; or
performing a full synchronization search when otherwise.

3. The method of claim 1, wherein the establishing of the synchronization comprises selecting a first demodulation reference signal (DMRS) from a first user equipment (UE) among a plurality of DMRSs from a plurality of UEs as a synchronization reference responsive to being in unicast communications with the plurality of UEs.

4. The method of claim 3, wherein the selecting of the first DMRS from the first UE as the synchronization reference comprises selecting the first DMRS responsive to either or both of:
a reference signal received power (RSRP) of the first DMRS being higher than RSRPs of other DMRSs of the plurality of DMRSs; and
a priority level associated with the first DMRS being higher than priority levels of the other DMRSs of the plurality of DMRSs.

5. The method of claim 1, wherein the establishing of the synchronization comprises maintaining a plurality of synchronization references based on a plurality of demodulation reference signals (DMRSs) from a plurality of user equipment (UEs) when in a plurality of unicast communications with the plurality of UEs.

6. The method of claim 1, wherein the establishing of the synchronization comprises:
selecting either or both of a SL synchronization signal block (S-SSB) and a demodulation reference signal (DMRS) as a synchronization reference; and
performing synchronization based on either or both of:
a SL synchronization signal (SLSS) identity (SSID) detection-based synchronization search, and
a wakeup channel DMRS or sequence-based synchronization.

7. The method of claim 6, wherein the selecting comprises selecting based on pre-configured information or selecting based on a configuration received in a signal.

8. The method of claim 1, wherein the establishing of the synchronization comprises performing SL synchronization based on a demodulation reference signal (DMRS) in one or more of a first sidelink control information (SCI) of a two-stage SCI transmission, a second SCI of the two-stage SCI transmission, and a data channel.

9. The method of claim 8, wherein the performing of the SL communication comprises receiving a bitmap or an identification (ID) carried in the second SCI indicating which user equipment (UE) is to wake up in a discontinuous reception (DRX) operation during a DRX_On duration.

10. The method of claim 1, wherein the performing of the SL communication comprises maintaining the SL communication between a first user equipment (UE) and a second UE by:
the first UE transmitting a signal to inform the second UE of a SL synchronization reference change by the first UE; and
the second UE determining a new synchronization timing which is used by the first UE and the second UE in maintaining the SL communication during the SL synchronization reference change by the first UE.

11. The method of claim 10, wherein the signal indicates information related to the new synchronization timing by indicating either:
a timing offset as a difference between the new synchronization timing and a current synchronization timing, or
a point in time at which the new synchronization timing becomes effective.

12. The method of claim 10, wherein the new synchronization timing is determined by the second UE determining to apply the new synchronization timing after a predefined period of time.

13. The method of claim 10, wherein the signal is transmitted by the first UE signaling to the second UE via one or more of a wakeup channel, a first sidelink control information (SCI) of a two-stage SCI transmission, a second SCI of the two-stage SCI transmission, and a data channel.

14. The method of claim 1, wherein the establishing of the synchronization comprises performing a SL synchronization search according to a search pattern which is aligned with a pattern of a discontinuous reception (DRX) operation by performing a search during each of a plurality of DRX_On durations of the DRX operation.

15. The method of claim 1, wherein the establishing of the synchronization comprises performing a dual-period SL synchronization search according to a first search pattern and a second search pattern each of which being aligned with a pattern of a discontinuous reception (DRX) operation by:
performing a first search during each of a plurality of DRX_On durations of the DRX operation; and
performing a second search longer than the first search during and around each of some but not all of the plurality of DRX_On durations.

16. The method of claim 1, wherein the establishing of the synchronization comprises synchronizing based on a wakeup signal (WUS) transmitted by a first user equipment (UE) to a second UE.

17. A method, comprising:
establishing synchronization in a vehicle-to-everything (V2X) network; and
maintaining a sidelink (SL) communication during a SL synchronization reference change by using signaling via one or more of a wakeup channel, a first sidelink control information (SCI) of a two-stage SCI transmission, a second SCI of the two-stage SCI transmission, and a data channel.

18. The method of claim 17, wherein the maintaining of the SL communication comprises maintaining the SL communication between a first user equipment (UE) and a second UE by:
the first UE transmitting a signal to inform the second UE of a SL synchronization reference change by the first UE; and
the second UE determining a new synchronization timing which is used by the first UE and the second UE in maintaining the SL communication during the SL synchronization reference change by the first UE.

19. The method of claim 18, wherein the signal indicates information related to the new synchronization timing by indicating either:
a timing offset as a difference between the new synchronization timing and a current synchronization timing, or
a point in time at which the new synchronization timing becomes effective.

20. The method of claim 18, wherein the new synchronization timing is determined by the second UE determining to apply the new synchronization timing after a predefined period of time.
